(19) United States
(12) Patent Application Publication
(10) Pub. No.: US 2019/0275725 A1
(43) Pub. Date: Sep. 12, 2019

(54) Apparatus and a method for expanding and simultaneously filling containers

(71) Applicant: KRONES AG, Neutraubling (DE)

(72) Inventors: Thomas KITZINGER, Regensburg (DE); Cora HANESCH, Regensburg (DE); Andreas VORNEHM, Offenberg (DE); Andreas PENSE, Regensburg (DE); Dieter FINGER, Neutraubling (DE); Dominik MEIER, Parsberg (DE); Klaus VOTH, Obertraubling (DE); Christian BETZ, Geigant (DE)

(21) Appl. No.: 16/203,230

(22) Filed: Nov. 28, 2018

(30) Foreign Application Priority Data
Mar. 7, 2018 (DE) 10 2018 105 228.6

(51) Int. Cl. B29C 49/46; B29C 49/18; B29C 49/42; B29C 49/58; B65B 3/02; B65B 3/10

(52) U.S. Cl. CPC B29C 49/46; B29C 49/18; B29C 49/4268; B29C 49/58; B29L 2031/7158; B65B 3/10; B29C 2049/4664; B29C 2049/5837; B29C 2049/5868; B65B 3/022

(57) ABSTRACT

An apparatus for expanding plastic preforms into plastic containers by a liquid medium using at least one forming station that fills and expands the plastic preforms used in the liquid medium using at least one supply device that supplies the liquid medium to a filling device of this forming station, wherein this filling device is configured to fill the liquid medium into the plastic preforms, and wherein the apparatus has a pressure generation device that supplies the liquid medium under pressure to the filling device. The pressure generation device has at least two pressure generation units that are configured to provide the liquid medium under pressure to the filling device.

The present invention relates to an apparatus and a method for producing liquid containers and in particular beverage containers. Such methods have been known from the prior art for a long time. In conventional methods, heated plastic preforms are initially expanded into plastic bottles, which is carried out for example in blow moulding machines. These containers thus expanded are subsequently filled with a filling material such as for example a beverage.

In recent times, also apparatus and methods have become known wherein plastic preforms are immediately filled with the filling material to be filled in and are also expanded in the process. It is known that to this end a pressure generation device or a pressure application device, such as a pump or a piston, is used to generate the pressure by means of which the liquid filling material is filled into the plastic preform to be expanded. To this end, very high power outputs are at times necessary for driving such pistons. It is also desired at times to fill the containers not with a pure product but with a product mix.

Presently, a moulding unit is used for moulding containers with a liquid medium, which subsequently remains in the container, which is roughly made up of two assemblies. These assemblies are on the one hand defined by a filling cylinder (hereinafter also referred to as a pressure generation device) and on the other hand are defined by a filling head (hereinafter referred to as filling device). In the prior art, the filling cylinder is designed to be single-acting and is supplied with a liquid medium, in particular the filling material, from a central liquid reservoir via a supply line. In the prior art, the supply line between the central liquid reservoir and the filling cylinder may be shut off using a shut-off device.

Once the filling cylinder is filled, the shut-off device is closed and the flow is shut off. During a moulding process, the liquid medium is pressed from the filling cylinder into the filling head.

The connection between the filling cylinder and the filling head is here implemented by means of at least one channel, but in the prior art, these channels cannot be shut off. A continuous throughflow from the filling cylinder to the filling head is possible at any time.

Prior to the moulding process, the filling head is placed on the plastic preform and seals in particular also the interface with the plastic preform. In the prior art, the filling head is tightly closed using a sealing plug.

Once a primary pressure has been adjusted in the filling head, in particular by the movement of the filling piston, the sealing plug is opened. This step initiates the forming process, wherein the plastic preform is formed into a container under the effect of the liquid medium and, if present, also a stretching rod.

In order to transfer the contour of this form onto the container in an optimum manner, a period of time with a constant internal pressure of the container (pressure holding time) is required, which in the prior art is realised by holding the piston stationary.

The present invention is based on the object of designing such apparatus and methods in a more efficient and more versatile manner. Also, where possible, the high peak power outputs for pressure generation devices should be reduced. According to the invention, these objects are achieved by means of the subject matters of the independent claims. Advantageous embodiments and developments are the subject of the dependent claims.

An apparatus according to the invention for expanding plastic preforms into plastic containers by means of a liquid medium has at least one forming station that fills and expands the plastic preforms with the liquid medium. Further, the apparatus has at least one supply device that supplies the liquid medium to a filling device of this forming station, which filling device is suitable and destined for filling the liquid medium into the plastic preforms, and wherein the apparatus has a pressure generation device that supplies the liquid medium under pressure to the filling device.

According to the invention, the pressure generation device has at least two pressure generation units, which are suitable and destined to provide and/or supply the liquid medium under pressure to the forming station.

Therefore, instead of using the one pressure generation unit as conventionally used in the prior art, it is suggested to use two pressure generation units or even more pressure generation units. This provides various advantages. Thus for example, the variability is enhanced because as a result of the two pressure generation units, also different products may be supplied. Also, in this way the performance requirements for just one pressure generation unit are reduced, as a result of which they may be dimensioned smaller or may be operated with a lower output.

Within the scope of the present application, the term forming station is to be understood to refer to the entire system, which in particular also includes at least one pressure generation device and at least one filling device. The term filling device is understood to be that part of the apparatus that fills the liquid into the respective container.

In a further advantageous embodiment, the apparatus has a multiplicity of such forming stations. In this connection it is possible and preferred that each of these forming stations has associated therewith in each case two or, where appropriate, more pressure generation units. Preferably, the apparatus has a carrier on which the forming stations are disposed. In particular, this may be a rotatable carrier and in particular a carrier that is rotatable about a specified rotary axis, on the outer circumference of which the forming stations are disposed. It would however also be conceivable for the forming stations to be transported, at least in sections, along a rectilinear transport path. Thus, the forming stations could for example be provided on a revolving chain. It would also be conceivable for the forming stations to be transported along a straight line or for the containers to be introduced into or transported to stationary forming stations.

In a further preferred embodiment, the forming station has a forming mould, within which the plastic preforms may be disposed so as to expand them using the liquid product. These forming moulds may be designed in such a way that the plastic preforms are expanded against the inner walls of these forming stations.

In a further advantageous embodiment, the device has a pressure measuring device that measures at least temporarily a pressure of the medium to be filled in. This pressure measuring device may be disposed for example on a filling head (also in particular in an area of the filling device).

In a further advantageous embodiment, the apparatus has a support means in order to place the filling head so as to rest against the respective plastic preform.

In a further preferred embodiment, the forming station has a stretching rod that can be introduced into the inside of the plastic preforms in order to expand the latter in the longitudinal direction. In this connection it is also possible for the stretching rod to be formed as a hollow body and to have, on the inside thereof, a channel for passing a flowable, in particular liquid medium.

In the prior art, the problem may at times occur that the liquid to be filled in cools a plastic preform more quickly than air, so that very high liquid speeds are required in order to expand the plastic preform. The reason is that the plastic preform should where possible still be formed in a hot condition, in particular in order to avoid stress whitening. Thus for example in the case of a 1.5 litre bottle, an average volume flow of 15 l/sec would be required within 0.1 seconds, which in turn means relatively high stress in respect of dimensioning a drive of the pressure generation device. Also the nominal widths of the components are kept very high as a result of the very high volume flow.

Thus, in order to find, despite everything, in the case of larger containers a drive that still has torque reserves, a changeover to a different concept would be required. If even larger bottle types are to be produced, higher volume flows will have to be realised. Moreover, due to the higher flow speeds, the counterpressure of the head and the liquid-carrying components increases. This, too, requires that the drive has to cope with higher loads. These two situations are in conflict and can therefore lead to great problems in respect of drive optimisation, because components that can cope with higher loads usually also have a higher inertia and are therefore exactly not capable of realising greater dynamics.

The present invention overcomes this problem by providing two pressure generation devices which on the one hand may jointly produce the respective pressure level and/or the necessary overall volume flow, however on the other hand allow particularly heavy components to be dispensed with.

It is therefore suggested, as mentioned above, for pressure generation to be carried out not by just one single drive or by one pressure generation unit, but by a plurality thereof and in particular by a plurality thereof at the same time. This may, as will be described in more detail below, be advantageous both for pumps and for piston/cylinder drives. The requirements of the respective drives with regard to dynamic stress, diameter of the piston will be significantly lower, if these requirements are met in particular by means of a skilled parallel connection or, if appropriate, also with a series connection of the drive components.

In a further advantageous embodiment, the two pressure generation units are connected in parallel in such a way that they can jointly supply the liquid medium to the forming station and preferably also supply it at the same time. In this connection it is possible for both pressure generation units to be operated in parallel, i.e. to be driven in the same way. It would also be possible for the pressure generation units to be driven differently, for example in order to be able to meet the different pressure and volume flow requirements in the case of a filling and expanding process. Moreover, however, also a series connection of the pressure generation units would be possible.

In a further preferred embodiment, the at least two pressure generation units or both pressure generation units are each connected with the filling device via liquid lines. Preferably, these are partially separated and preferably completely separated liquid lines that connect the two pressure generation units in each case with the filling device, which means in particular with the filling head. In this way, the liquid may be supplied to the filling device by at least two separate lines.

Preferably, the pressure generation units also have at least partially and preferably substantially completely separate lines, which again supply the liquid (to be filled in) to the latter (in particular from a reservoir).

In a further advantageous embodiment, the filling device also has a collection space for receiving the liquid medium. The liquid lines mentioned above can flow into this collection space. Particularly preferably, the two supply lines open into the collection space at different positions, for example at different positions in a circumferential direction of the filling means. The circumferential direction may be defined for example with regard to the longitudinal direction of the plastic preforms to be expanded.

In a further preferred embodiment, the filling device has a collection space for receiving the liquid medium. This collection medium is, at least at times, in flow communication with each of the pressure generation units. However, it would also be possible here for valves to be provided between the collection space and the pressure generation device, which valves can control a product flow from the respective pressure generation unit to the collection space.

In a further advantageous embodiment, the pressure generation units each have drive units which particularly preferably may be controlled independently from each other. These drive units may preferably have motorised drives and in particular electromotive drives and in particular linear motor drives. Thus, for example, a linear motor may be provided that carries out a piston movement. This linear motor may be connected with the piston unit, which will be described in more detail below.

The drive unit may be a transmission unit, for example a planetary gear. Particularly preferably, the drive unit may also have a spindle drive.

In a further preferred embodiment, the drive unit also has a position sensing unit that senses the position of a pressure cylinder. In this way, the supply of the liquid medium in the plastic preforms may be controlled and/or regulated in a targeted manner.

In a further advantageous embodiment, the pressure generation units each have a liquid chamber and a piston unit that can be moved relative to this liquid chamber. As a result of a movement of this piston unit, the liquid is here ultimately pressed into the containers. In a further preferred embodiment, at least one pressure generation unit and preferably both pressure generation units is/are pump units and in particular pump units selected from a group of pump units comprising hydraulic pumps, sinus pumps, axial piston pumps, bellows pumps, diaphragm pumps, scroll pumps, rotary piston pumps, eccentric screw pumps, screw conveyors, impellor pumps, chain pumps, annular piston pumps, hose pumps, helical spindle pumps, shake pumps, tooth belt pumps and the like.

In a preferred embodiment, the condensed volume flows generated by the pressure generation unit may be collected in the filling head which is seated in a manner so as to seal in particular towards the preform and particularly preferably provides for a constant flow front. Preferably, the filling head has a sealing plug which, depending on its position, can free the path to the plastic preform. Moreover, it would also be conceivable for the pressure generation units to have a piston unit that can at least at times be additionally boosted in order to generate pressure peaks.

Apart from that it would also be conceivable for different pressure levels to be realised by the two pressure generation units, wherein particularly preferably annular channels are available that are used for holding or maintaining these different pressure levels. In this way it would be possible to achieve different pressure levels. Thus, for example, it would be conceivable for a first annular channel to have very large cross sections, in order to provide in this way a low pressure level and in order to finish-form the container as quickly as possible.

A second pressure stage may have a very high pressure level in order to ensure the shaping of the container. To this end, for example an annular channel with a small cross section may be available. In this way, the two pressure stages could thus be collected in the filling head (i.e. the filling device).

In a further embodiment it would also be possible to provide a plurality of pistons and/or cylinders, in order to be able in this way to use different products, for example to store them in the pressure cylinders and to supply them to the filling means either in the mixed condition or individually.

Further it would be possible to provide higher volume flows with a consistent torque reserve of the drives. In the case of a larger dimensioning of a drive it is possible that the dynamics can no longer be realised to the required extent and the drive can no longer cope with the corresponding loads.

Apart from that, the invention would also facilitate the use of a very large spread of volumes of the customer objects. If for example a customer wants to produce a 0.5 l bottle, it would for example be possible to traverse just one piston, and in the case of for example a 6.0 l bottle to apply the volume flow using two or three pistons. In this way it is possible to adjust a corresponding system in each case to different customer requirements, with it preferably also being possible to cover any required maxima by way of a skilled combination of the pressure generation units.

In a further advantageous embodiment, the filling device comprises a closing element which in at least one position blocks any flow of the liquid into the container and in at least one position allows such a flow. In this connection, this may for example be the above-mentioned sealing plug which, depending on its position, can prohibit or admit a liquid flow into the plastic preform.

The present invention is further directed to a method for expanding plastic preforms into plastic containers by means of a liquid medium and in particular by means of filling material, wherein at least one forming station fills and expands the plastic preforms with the liquid medium and wherein the liquid medium is supplied to a filling device of the forming station by means of a supply device, wherein the filling device fills the liquid medium into the plastic preforms and wherein a pressure generation device of the forming station supplies the liquid medium under pressure.

According to the invention, the pressure generation device has at least two pressure generation units that provide the forming station with the liquid medium under pressure.

It is therefore suggested also on the side of the method to provide the pressure for expanding the plastic preforms by means of at least two pressure generation units. Preferably, these pressure generation units supply the pressure, at least at times, simultaneously.

An apparatus according to the present invention for expanding plastic preforms into plastic containers by means of a liquid medium comprises at least one forming station that fills and expands the plastic preforms with the liquid medium. Further, the apparatus has at least one supply device that supplies the liquid medium to a filling device of this forming station, which filling device is suitable and destined to fill the liquid medium into the plastic preform, and wherein the apparatus has at least one pressure generation device that supplies the liquid medium under pressure to the filling device.

According to the invention, the pressure generation device comprises a prestressing unit that prestresses at least one element of the pressure generation device.

In this embodiment too, it is suggested to reduce the peak power, however in this case it is in particular suggested to prestress at least one element of the pressure generation device, for example a piston unit.

In order to reduce the load of the drive of the pressure generation device, it is also suggested to operate using a prestressing unit for this drive. In particular, this is a translatory prestressing unit.

In a preferred embodiment, the pressure generation device comprises a reception space for the liquid medium as well as a piston unit that is movable in relation to this reception space, in order to urge the liquid medium towards the filling device by means of a piston movement of this piston unit. This means that in this embodiment the pressure generation device is designed as a movable piston or includes the latter.

Particularly preferably, the prestressing unit acts on this piston unit at least indirectly and urges it in a predetermined direction. In particular, the prestressing unit urges the piston unit in a direction that effects a reduction of the receiving space and in particular a flow or urging of the liquid medium in the direction of the plastic preform to be expanded and to be filled.

In a further advantageous embodiment, the prestressing unit prestresses the element of the pressure generation device in a translatory direction. Preferably, the piston unit therefore moves in a translatory or linear direction, and the prestressing unit also effects a prestressing in exactly this direction.

In a further advantageous embodiment, the prestressing unit includes a prestressing element that is selected from a group of prestressing elements including mechanical springs, permanent-magnetic springs, pneumatic springs, hydraulic elements, linear motor elements, combinations thereof and the like.

Thus for example a mechanical spring may be provided that acts on the piston unit, which is hinged for example to a rear side of the piston unit. Apart from that, the prestressing unit may also be implemented using a hydraulic spring. Thus for example a hydraulic spring may be ensured via a pre-feed pump. Moreover however, also a rotary prestressing unit may be provided, for example of the torsion spring type. Apart from that, also a separate pump may be provided in order to generate the prestress. It would also be conceivable to provide a pressure transducer with pressurised air for this purpose.

Preferably, a prestressing unit engages on a rear side of the piston unit. It would however also be possible for the prestressing unit to be provided outside of the pressure generation device, in particular in a separate cylinder that has for example a common axis with the pressure generation device or the filling piston.

It is pointed out that the embodiments described here can also be combined with the above-mentioned embodiments. It is also possible to conceive embodiments wherein both two or more pressure generation devices and a prestressing unit are used. Instead of the term prestressing unit, also the terms loading device or urging device may be used.

In a further advantageous embodiment, the prestressing unit generates, on the inside of a reception space for the liquid medium, a pressure that is greater than 2 bar, preferably greater than 4 bar, preferably greater than 6 bar, and/or the prestressing unit generates, on the inside of the reception space for the liquid medium, a pressure that is less than 40 bar, preferably less than 30 bar and particularly preferably less than 20 bar.

The level of the (mechanical, pneumatic or hydraulic) prestress is preferably selected such that the moulding times for the plastic preforms are reduced to a minimum using an overall system of the drive (for example an overall system consisting of motor, spindle and prestressing unit).

In a preferred embodiment, the apparatus comprises a pressure reservoir and in particular a pressure tank that feeds the respective prestressing unit. This may be the case in particular in a hydraulic or pneumatic prestressing unit. It is possible here for the prestressing unit to act only temporarily, for example supports only temporarily (for example only at the end or at the beginning) or during the entire traversing path results in a (either constant or different) prestress or support.

In a further advantageous embodiment, the prestress level may be modified. It would thus be possible for the prestress level to be adapted for example to the expansion of different containers. It would be possible here for the prestress level to be constant during the entire movement of the piston means, but it would also be conceivable for the prestress level to be changed during the movement of the piston or to occur for example only during certain periods of time.

In other words, the level of prestress may have a fixed value (for example be dynamically adjustable in the case of a mechanical spring (e.g. in the case of a pneumatic spring over the level of the pressure) and/or to be switchable (e.g. a pneumatic or hydraulic spring)).

Moreover it would also be conceivable for such a prestress to be pneumatically designed and for a corresponding reservoir or tank to be dimensioned such that the support force is almost constant over the traversing path.

In this way, the filling of the tank may be realised by moving the piston unit up and down (in particular if suitable valves are switched by compressing the air on the rear side of the filling piston or of the prestressing piston and in this way at least part of the air requirement for a compensation tank is produced.

However it would also be possible to use pressure lines to apply different pressures, for example a 10 bar low-pressure line or a 40 bar high-pressure line.

In a further advantageous embodiment, the pressure generation device comprises a drive unit, in particular an electric motor. This drive unit may here have a brake unit that can, if required, block the movement of the piston unit.

In a further advantageous embodiment, the pressure generation device comprises a piston unit which at least at times is seated on a piston seat. In this case, the prestressing force may be passed directly to the piston seat.

In a further advantageous embodiment, the prestressing unit may be switched off. Thus for example in the case of an emergency stop, the prestressing unit may be switched off and/or a holding brake of a motor unit, for example of a servomotor, may be activated.

In an advantageous embodiment, the drive unit for driving the cylinder unit has a nut integrated into a rotor and a spindle (a hollow shaft).

A servomotor with an integrated spindle has many advantages with regard to installation space, weight, dynamics and flexibility. Thus for example it would also be possible to go without any connection elements between the drive unit and the linear screw.

Moreover it would also be possible for the drive unit to be implemented as a linear motor. Thus, a linear motor may be directly connected to the piston unit so as to apply the driving force in this way. In this case, too, it would be possible to additionally apply a prestress.

In a further advantageous embodiment, the apparatus may have a lever unit that is suitable and destined to actuate two pressure generation devices or two cylinders. Thus for example the lever unit may be a toggle lever that applies the required forces. A pressure profile during moulding of the container requires a rapid moulding process, so that in the case of a nearly finish-moulded bottle, a short path and large holding forces could be used. For such an application, a toggle lever is particularly advantageous and will be described in more detail below.

This toggle lever could for example be driven by a servomotor with a linear spindle or optionally by a transmission or by any other drive unit that can be traversed in the longitudinal direction or by a rotary drive unit. It is also preferably possible here again to apply a prestress, however it is pointed out that this concept is possible also without the prestress described here.

As a result of the geometry and the operative principle of a toggle lever, very high speeds can be achieved at the beginning of the travel path and thus also high volume flows, whereas towards the end and at the bottom point of the piston drive, the volume flows decrease and the force rises theoretically to infinity. Thus, also high holding forces could be realised.

Apart from that, also a hydraulic drive unit could be used as the drive unit. As a result of the high pressures that are customary in hydraulics, it would be possible, due to the smaller cross-sections required to displace a piston with a certain force, for smaller volume flows to be realised which simplify a drive. Thus for example, a hydraulic pump could pump, for example via a bypass, the required volume flow and, if required, could pump into the hydraulic cylinder. The latter would have a connection to the filling piston to be driven or the piston unit.

The hydraulic cylinder could however also include a pump unit that realises a high degree of dynamics, or an axial piston pump, in order to provide in this way the required dynamics of the drive.

It would also be possible here to provide a system with a pump unit and/or a pressure generation device per forming station, or an apparatus with one or more pump units in parallel, in order to be able to drive a plurality of stations from one hydraulic unit.

Altogether, the prestress unit offers the advantage that there are more possibilities with regard to drive calculation and also larger volume flows with a same basic principle (piston or cylinder). Also, the costs of the drive units would be lower than in the case of a larger drive without a prestressing unit.

It is pointed out that the prestressing unit will be represented below also as a loading device or as a force loading device that is suitable and destined to load the element of the pressure generation device in a predefined direction.

The present invention is therefore further directed to a method for expanding plastic preforms into plastic containers using a liquid medium, wherein at least one forming station fills and expands the plastic preforms with the liquid medium, and wherein the liquid medium is supplied to a filling device of the forming station using at least one supply device, wherein the filling device fills the liquid medium into the plastic preforms and wherein a pressure generation device supplies the liquid medium under pressure to the forming station.

According to the invention, at least one element of the pressure generation device is prestressed, at least temporarily, by means of a prestressing unit. Further advantages and embodiments will become evident from the attached drawings, wherein:

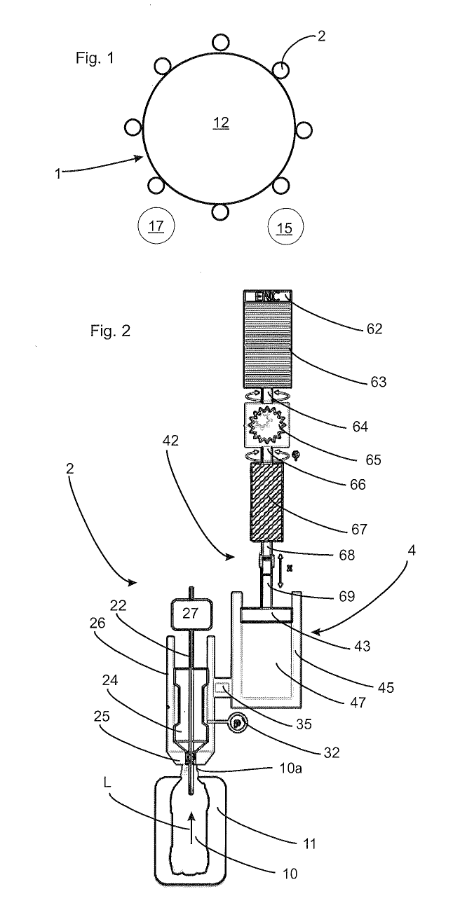

FIG. 1 shows a grossly schematic representation of an apparatus according to the invention;

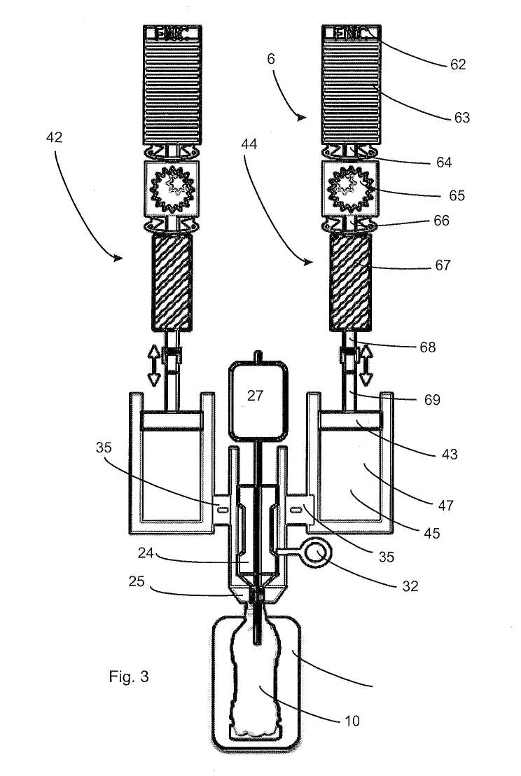

FIG. 2 shows a representation of a forming station according to the applicant's internal prior art;

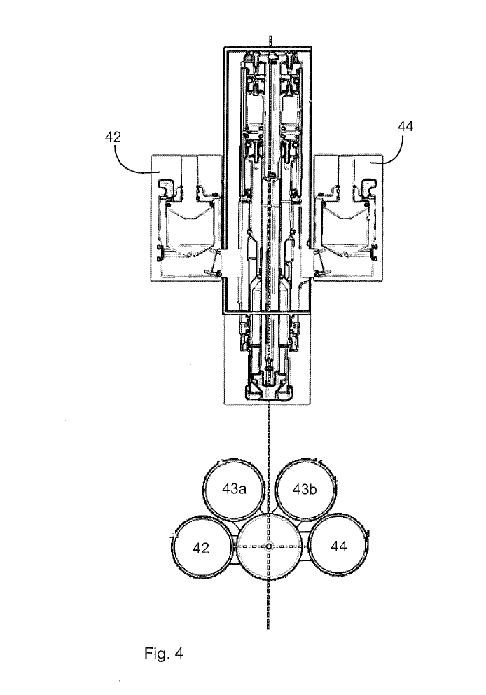

FIG. 3 shows an representation of a forming station according to the invention;

FIG. 4 shows a further representation of the forming station according to the invention;

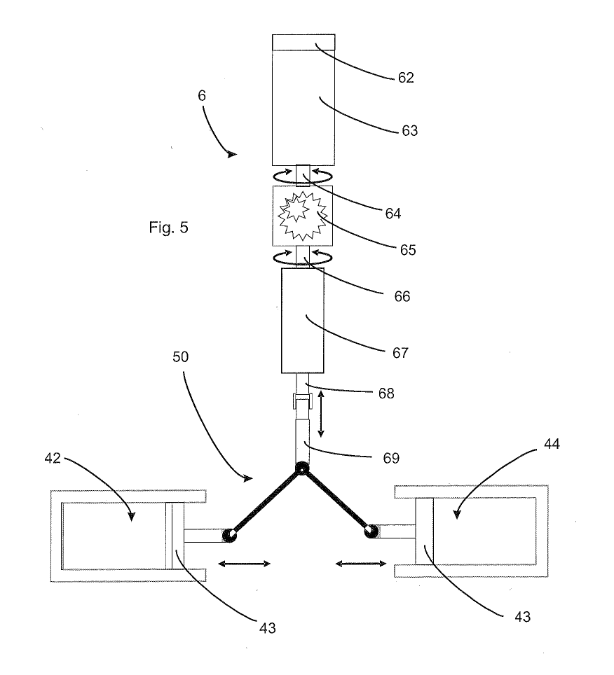

FIG. 5 shows a representation of a pressure generation device with a toggle lever;

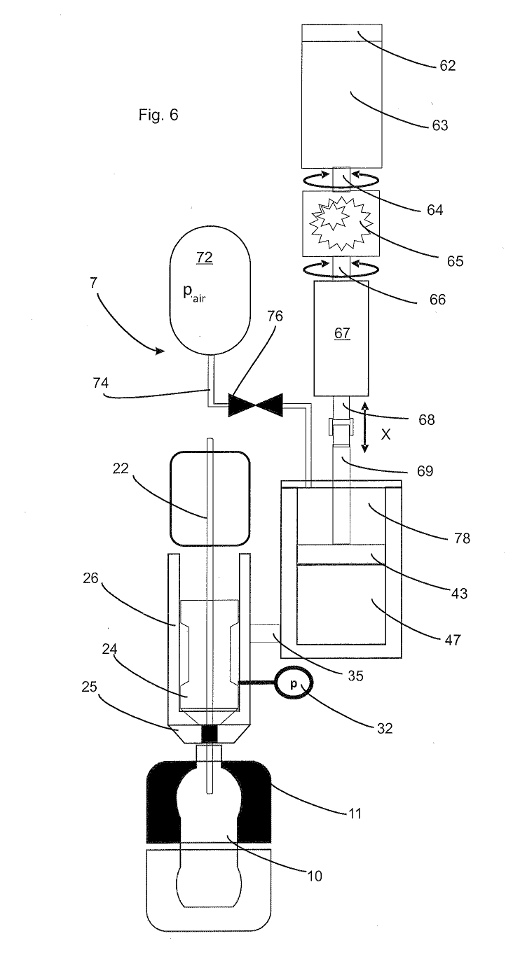

FIG. 6 shows a representation of a forming station with a prestressing unit;

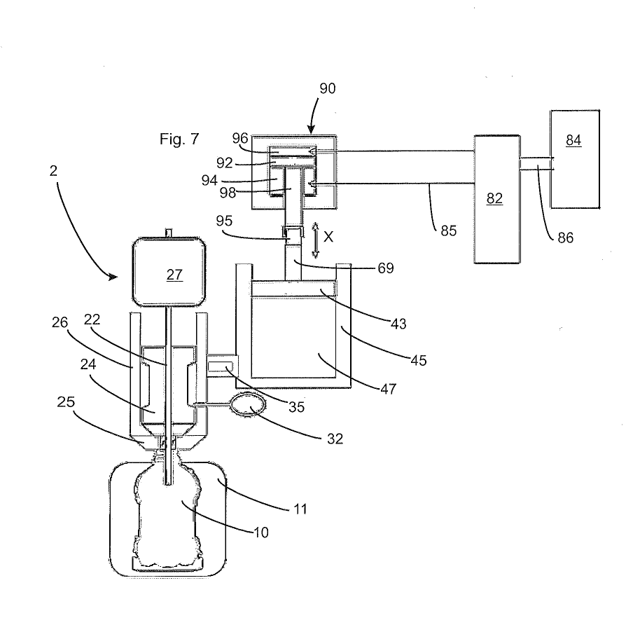

FIG. 7 shows a representation of a forming station with a hydraulic or pneumatic drive unit.

FIG. 1 shows a schematic representation of an apparatus according to the invention for forming and filling containers. This apparatus comprises a rotary carrier 12 on which a multiplicity of forming/filling devices is disposed. These forming devices are used, as mentioned above, for filling and expanding the plastic preforms at the same time with a container. Plastic preforms are supplied to the apparatus via a supply device 15 such as a supply star, and the finished and filled containers are subsequently transported off from the apparatus via a discharge device 17.

FIG. 2 shows a forming station 2 according to the applicant's internal prior art. Here, the actual filling device is provided, which has an application device 25 that can be applied to a mouth 10a of the plastic preform to be expanded, in order to fill and shape in this way the plastic containers 10. To this end, the forming device has an expansion mould 11, within which the plastic preforms are expanded into the plastic bottles or plastic containers. Reference numeral 26 identifies a filling housing, within which a closure device 24 such as a closure plug is provided. As a result of a movement of this valve body in the longitudinal direction L of the container, the supply of liquid into the container 10 can be regulated.

Reference numeral 22 identifies a so-called stretching rod that can be introduced into the inside of the containers, in order to stretch the latter in this way in the longitudinal direction thereof. To this end, the apparatus includes a drive unit 27 that is suitable and destined for moving the stretching rod in the longitudinal direction thereof.

Reference numeral 4 identifies in its entirety the pressure generation device that supplies the liquid under pressure to the plastic container. Here, the pressure generation device has only one pressure generation unit. This pressure generation means, more specifically the pressure generation unit, has a reception space 45, within which the liquid 47 to be filled in is provided. Apart from that, also supply lines may be provided which (for example starting from a reservoir, not shown) supply the liquid to the reception space 45.

Reference numeral 43 identifies a piston unit that is movable in the direction x, in order to transport in this way the liquid via a connection line 35 to the actual filling head (referred to above also as a filling device). Reference numeral 62 identifies the drive unit in particular in the form of a servomotor 63 that drives the movement of the piston unit 43. To this end, the drive unit generates a rotary movement that is output via an output shaft 64. Reference numeral 65 identifies a transmission unit, here a planetary gear, and reference numeral 66 shows a further output shaft. This output shaft in turn drives a linear spindle 67, which moves rod elements 68 and 69 which are connected to each other via a coupling and on which in turn the piston unit is mounted.

Therefore, in the embodiment shown in FIG. 2, the apparatus only has one single pressure generation device that has to apply the pressure for filling and expanding the containers. Reference numeral 32 identifies a pressure measuring device that measures a pressure occurring in the filling housing 26.

FIG. 3 shows an embodiment of an apparatus or a forming station 2 according to the invention. Here, the actual filling head is designed in a way similar to the embodiment shown in FIG. 2 and will therefore not be explained in more detail. Contrary to the embodiment shown in FIG. 2, however, two pressure application units 42 and 44 are provided here. These may be designed in the same way and have already been described above, so that this will not be repeated. It is possible for these pressure application units to operate simultaneously, however, they may also fill the containers with a liquid medium with a temporal offset. Apart from that it would also be possible for these two pressure application units 42 and 44 to receive different liquids in the respective reception spaces 47, so that for example a product mix may be supplied to the container 10.

FIG. 4 shows an embodiment in which a total of four pressure application units 42 to 44 are present, which are again connected to the actual filling device via connection lines. These four pressure generation units may contain several different products, for example four different products. In this case it would be possible that the drive force is again minimised and a product mix is filled in. It would be possible here that one product is present in each of these pressure generation devices, which is pressed into the plastic preforms to be formed either at the same time or sequentially. Here, the required drive output for one of these four pressure generation units may be significantly reduced compared to the power requirement where just one single pressure generation unit is used.

Apart from, or instead of, the above-described drive devices, however, also hydraulic drive units or motors with a nut integrated in the rotor and a spindle may be provided, which is for example implemented as a hollow shaft.

FIG. 5 shows a further embodiment of the present invention. In this embodiment, again two pressure generation units 42 and 44 are provided, however only the actual filling devices are shown here. In this embodiment, just one drive of the above-identified type, but in addition a lever means 50 is provided, which transfers the forces thus generated to the piston unit 43. This lever unit is here implemented as a so-called toggle lever that is hinged onto the two piston units 43 so as to move the latter. In this case, the required forces are applied using a toggle lever. The pressure profile during the forming of the containers requires here a rapid moulding process and, when the bottle is nearly finish-formed, a short travel path and large holding forces.

FIG. 6 shows a further embodiment of the present invention. In this embodiment, the actual filling device is designed in a way similar to the above-mentioned filling device. Also, the drive device 62-69 is designed in a way similar to the one above and will therefore not be described here. Additionally, however, the apparatus shown in FIG. 6 has a prestressing unit or a preloading unit 7, which prestresses the piston device 43 downwards in the direction x. In the embodiment shown here, this prestressing unit has a reservoir 72, in which for example air can be stored under a predetermined pressure. This air can be fed into the space 78 via a connection line 74 and a valve 76. In this reception space, the pressurised air can additionally load the piston means 43, so that this is urged downwards.

Thus, in the embodiment shown in FIG. 6, the area of attack or the region of attack for the prestressing unit is the rear side of the piston means 43.

FIG. 7 shows a further embodiment of the apparatus according to the invention. In this embodiment, too, the actual filling device is designed in the way shown above. Here, too, a reception space 47 and a piston unit movable relative to this reception space are present. The embodiment shown in FIG. 7 is different with regard to the type of drive for the piston unit. As a drive unit, a hydraulic or pneumatic drive unit is used here. To this end, a hydraulic chamber 94 is provided again, in relation to which a piston element 92 is also movable in the direction x. Reference numeral 98 identifies a piston rod which in turn is coupled to the piston unit 43 by means of a coupling device.

Reference numeral 82 identifies a valve that can be switched in a controlled manner. By means of an accurate switching of this valve 82, a volume could be adjusted in a time-controlled manner. In addition, also mechanical stops or a modified volume flow of a pump could conceivably be provided within this drive unit 90. Reference numeral 84 identifies a corresponding hydraulic pump that is connected to the valve 82 via a connection line 86. The valve may be controlled here in such a way that it could pas a hydraulic medium both into the space section 96 and into the space section (or the hydraulic chamber) 94. It would also be conceivable here for the hydraulic drive unit 90 described here to have to be connected to the piston unit 43 only by means of a rod, and in this way intensively contaminated components would have no direct connection. Reference numeral 85 identifies a connection line.

As a hydraulic pump, the most varied pump types from the prior art may be considered. In addition, also the coupling device 95 between the piston rod 98 and the filling piston rod 69 may effect a real separation of the components.

Preferably, therefore, the apparatus has a coupling device that couples at least one element of the drive unit with at least the piston unit.

By means of the prestressing unit described here, which may also be achieved by means of the embodiment shown in FIG. 7 or the variant thereof, several objects are achieved. In this way, the costs of the drive unit are reduced compared to the case of a corresponding larger drive without a prestressing unit. Also, the use of a pressure connection could theoretically be eliminated.

The use of a hydraulic drive unit has the advantage that it usually has smaller dimensions. Apart from that, shorter switching times may often be realised, and it would be possible to partially use components known from the prior art or prefabricated components.

The applicant reserves the right to claim all of the features disclosed in the application documents as being essential to the invention, in as far as they are novel over the prior art either individually or in combination. It is further pointed out that features were described in the individual figures, which taken by themselves may be advantageous. A person skilled in the art will immediately recognise that a certain feature described in a figure may also be advantageous without adopting further features from this figure. A person skilled in the art will further recognise that advantages may be achieved also by combining several features shown individually or in various figures.

### LIST OF REFERENCE NUMERALS

1 Apparatus

2 Forming station

4 Pressure generation device

6 Drive unit

7 Prestressing unit, loading unit

10 Plastic containers

10a Mouth

11 Expansion mould

12 Rotatable carrier

15 Supply device

17 Discharge device

22 Stretching rod

24 Closure device

25 Application device

26 Filling housing

27 Drive unit

32 Pressure measuring device

35 Connection line

42, 44 Pressure generation unit

43 Piston unit

43a, b Pressure generation unit

45 Reception space

47 Liquid to be filled in

50 Lever unit

62 Drive unit

63 Servomotor

64 Output shaft

65 Transmission unit

66 Output shaft

67 Linear spindle

68 Rod element

69 Rod element

69 Filling piston rod

72 Reservoir

74 Connection line

76 Valve

78 Chamber

82 Valve

84 Hydraulic pump

85 Connection line

86 Connection line

90 Hydraulic drive unit

92 Piston element

94 Hydraulic chamber, chamber section

95 Coupling device

96 Chamber section

98 Piston rod

x Direction

1. An apparatus for expanding plastic preforms into plastic containers using a liquid medium having at least one forming station that fills and expands the plastic preforms using the liquid medium using at least one supply device that supplies the liquid medium to a filling device of this forming station, wherein said filling device is configured to fill the liquid medium into the plastic preforms, and wherein the apparatus has a pressure generation device that supplies the liquid medium under pressure to the filling device wherein the pressure generation device has at least two pressure generation units configured to provide the liquid medium under pressure to the filling device.

2. The apparatus as claimed in claim 1, wherein the two pressure generation units are connected in parallel in such a way that they each supply the liquid medium to the filling device.

3. The apparatus as claimed in claim 1, wherein the two pressure generation units are each connected to the filling device via liquid lines.

4. The apparatus as claimed in claim 1, wherein the filling device has a collection space for receiving the liquid medium, which collection space is in fluid communication, at least temporarily, with each of the pressure generation units.

5. The apparatus as claimed in claim 1, wherein the pressure generation units each have drive units.

6. The apparatus as claimed in claim 1, wherein the pressure generation units each have a liquid chamber and a piston unit configured to be moved relative to this liquid chamber.

7. The apparatus as claimed in claim 1, wherein at least one pressure generation unit is a pump unit and in particular a pump unit that is selected from a group of pump units consisting of a hydraulic pump, a sinus pump, an axial piston pump, a bellows pump, a diaphragm pump, a scroll pump, a rotary piston pump, an eccentric screw pump, a screw conveyor, an impeller pump, a chain pump, an annular piston pump, a hose pump, a screw spindle pump, a shake pump, and a tooth belt pump.

8. The apparatus as claimed in claim 1, wherein the filling device comprises a closure element that blocks the flow of the liquid into the container in at least one position and allows this flow in at least one position.

9. The apparatus as claimed in claim 1, wherein the pressure generation device has a toggle lever.

10. A method for expanding plastic preforms into plastic containers by a liquid medium using at least one forming station that fills and expands the plastic preforms using the liquid medium, wherein the liquid medium is supplied to a filling device of the forming station using at least one supply device, wherein the filling device fills the liquid medium into the plastic preforms and wherein a pressure generation device of the forming station supplies the liquid medium under pressure, wherein the pressure generation device has at least two pressure generation units that provide the liquid medium under pressure to the forming station.

11. The apparatus as claimed in claim 1, wherein the pressure generation units drive units are configured to be controlled independently of each other.
